(19) United States
(12) Patent Application Publication
(10) Pub. No.: US 2006/0070859 A1
(43) Pub. Date: Apr. 6, 2006

(54) Conveyor system and method of using

(75) Inventors: Joseph R. Pahlow, Oshkosh, WI (US); Alan R. Sumner JR., West Bend, WI (US); Dennis A. VanderHoeven, Beaver Dam, WI (US)

Correspondence Address: MICHAEL BEST & FRIEDRICH, LLP, 100 E WISCONSIN AVENUE, MILWAUKEE, WI, 53202, US

(73) Assignee: Arrowhead Conveyor Corporation, Oshkosh, WI (US)

(21) Appl. No.: 10/950,167

(22) Filed: Sep. 24, 2004

(51) Int. Cl. B65G 17/00

(52) U.S. Cl. 198/809; 198/860.1

(57) ABSTRACT

A conveyor system for carrying a conveyor belt. The conveyor system includes a first module having a frame and an elevator assembly including shuttles positioned on opposite sides of the belt and movable relative to the frame between a first position, in which the upper surface is positioned to move product along the belt, and a second position, in which the upper surface is spaced a distance from the belt in a direction substantially normal to the travel direction to remove product from the belt. The conveyor system also includes a second module for supporting the belt and transporting product from an upstream end of the second module to a downstream end of the second module and a third module having a drive assembly for driving the belt across the first, second, and third modules.

### FIELD OF THE INVENTION

The present invention relates to conveyors and methods of operating conveyors and, more particularly, to modular conveyor systems and methods of assembling and operating modular conveyor systems to move products between locations.

### BACKGROUND OF THE INVENTION

Conveyors are routinely used in warehouses, manufacturing facilities, storage facilities, and distribution centers to transport products between two locations. In a typical conveyor, an endless chain or belt is supported by a frame and is driven by a drive assembly for movement relative to the frame. Generally, the belt or chain supports products and moves the products between upstream and downstream locations.

### SUMMARY OF THE INVENTION

The present invention provides a conveyor system for carrying products. In some constructions and in some aspects, the conveyor system generally includes a frame, a conveyor supported on the frame for movement in a travel direction relative to the frame, and an elevator assembly supported on the frame and including a shuttle positioned adjacent to the belt. The shuttle includes an upper surface and is moveable relative to the frame between a first position, in which the upper surface is positioned to allow product to travel along the conveyor, and a second position, in which the upper surface is spaced a distance from the conveyor in a direction substantially normal to the travel direction to remove product from the conveyor.

The present invention also provides a frame assembly for carrying a conveyor belt. In some constructions and in some aspects, the frame assembly generally includes a pair of side supports and an intermediate support extending between the side supports. The intermediate support has a surface and is securable to the side supports in a first orientation to support a first belt and a second orientation to support a second belt.

In addition, the present invention provides a frame assembly for carrying a conveyor belt. The frame assembly generally includes first and second side supports and two or more intermediate supports positionable between the first and second side supports, each intermediate support having a surface. The surface includes a forwardly extending tongue and defines notches on opposite sides of the tongue. The frame assembly also includes a chute having a leading edge and a trailing edge. The leading edge includes a lip defining an opening. The chute is securable to the intermediate supports.

The present invention further provides a conveyor system generally including a first module having a frame and an elevator assembly supported on the frame. The elevator assembly includes shuttles positioned on opposite sides of the belt supported on the frame for movement in a travel direction. The shuttles include an upper surface and are movable relative to the frame between a first position, in which the upper surface is positioned to move product along the belt, and a second position, in which the upper surface is spaced a distance from the belt in a direction substantially normal to the travel direction to remove product from the belt. The elevator assembly also includes a second module for supporting the belt and transporting product from an upstream end of the second module to a downstream end of the second module. The elevator assembly further includes a third module for supporting the belt and transporting product. The third module has a drive assembly for driving the belt across the first module, the second module, and the third module.

The present invention also provides a method for selectively removing products from a conveyor of a conveyor system. The method generally includes the act of providing a conveyor system having a frame, a conveyor supported on the frame for movement in a travel direction relative to the frame, and support surfaces positioned on opposite sides of the conveyor. The support surfaces are in a first position to allow movement of product with the conveyor. The method also includes the acts of lifting the support surfaces to a second position in which the support surfaces are spaced a distance above the conveyor in a direction substantially normal to the travel direction to remove product from the conveyor and retracting the support surfaces to the first position.

Independent features and independent advantages of the present invention will become apparent to those skilled in the art upon review of the following detailed description, claims, and drawings.

### BRIEF DESCRIPTION OF THE DRAWINGS

FIG. 1 is a perspective view of a conveyor system including a first module, a second module, a third module, and a chain extending therebetween.

FIG. 2 is a perspective view of the first module shown in FIG. 1.

FIG. 3 is a top view of the first module shown in FIG. 1 with the chain removed.

FIG. 4 is a side view of the first module shown in FIG. 1.

FIG. 5 is a cross-sectional view taken generally along line 5-5 in FIG. 3.

FIG. 6 is a rear view of the first module shown in FIG. 1.

FIG. 7 is a perspective view of a drive assembly of the first module shown in FIG. 1.

FIG. 8 is cross-sectional view taken generally along line 8-8 in FIG. 7.

FIG. 9 is a front view of the drive assembly shown in FIG. 7.

FIG. 10 is a perspective view of an alternate construction of the first module of the conveyor system of the present invention.

FIG. 11 is a perspective view of a drive assembly of the first module shown in FIG. 10.

FIG. 12 is a perspective view of another alternate construction of the first module with a portion of the chain removed.

FIG. 13 is a perspective view of a support bracket of the first module shown in FIG. 1.

FIG. 14 is a front view of the support bracket shown in FIG. 13.

FIG. 15 is a top view of the support bracket shown in FIG. 13.

FIG. 16 is an end view of the support bracket shown in FIG. 13.

FIG. 17 is a perspective view of a conveyor return bracket of the first module shown in FIG. 1.

FIG. 18 is a front view of the conveyor return shown in FIG. 17.

FIG. 19 is a top view of the conveyor return bracket shown in FIG. 17.

FIG. 20 is a perspective view of a channel of the conveyor shown in FIG. 1.

FIG. 21 is a top view of the channel shown in FIG. 20.

FIG. 22 is a side view of the channel shown in FIG. 20.

FIG. 23 is a front view of the channel shown in FIG. 20.

FIG. 24 is a perspective view of the second module of the conveyor system of the present invention.

FIG. 25 is a top view of the second module shown in FIG. 24.

FIG. 26 is a front view of the second module shown in FIG. 24.

FIG. 27 is a perspective view of an alternate construction of the second module of the conveyor system of the present invention.

FIG. 28 is a top view of the second module shown in FIG. 27.

FIG. 29 is a front view of the second module shown in FIG. 27.

FIG. 30 is a perspective view of an another alternate construction of the second module of the conveyor system of the present invention.

FIG. 31 is a front perspective view of a third module of the conveyor system of the present invention.

FIG. 32 is a rear perspective view of the third module shown in FIG. 31.

Before at least one construction of the invention is explained in detail, it is to be understood that the invention is not limited in its application to the details of construction and the arrangements of components set forth in the following description or illustrated in the drawings. The invention is capable of other constructions and of being practiced or of being carried out in various ways.

Also, it is to be understood that the phraseology and terminology used herein with reference to element orientation (such as, for example, terms like “front”, “top”, “bottom”, “upper”, “lower”, “side”, “intermediate”, “upstream”, “downstream”, etc.) are only used to simplify description of the present invention, and do not alone indicate or imply that the element referred to must have a particular orientation. In addition, terms such as “first”, “second”, and “third” are used herein for purposes of description and are not intended to indicate or imply relative importance or significance.

### DETAILED DESCRIPTION

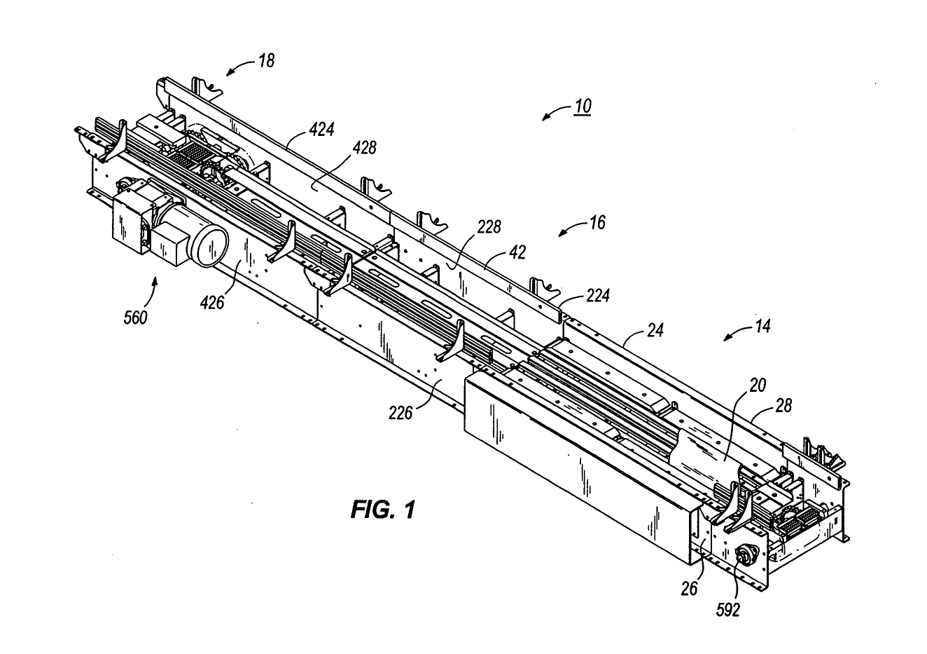

FIG. 1 illustrates a conveyor system 10 capable of transporting products P (e.g., boxes, tubes, cases, assemblies, subassemblies, packages, containers, etc.) between two or more locations. In the illustrated construction of FIG. 1 and in some aspects, the conveyor 10 includes a first module 14, a second module 16, a third module 18, and a conveyor, such as a belt or a chain, 20 extending across and between the first, second, and third modules 14, 16, 18. In other aspects and in other constructions, the conveyor system 10 can include combinations of one, two, four, or more of the first, second, and third modules 14, 16, 18.

In the illustrated construction of FIGS. 1-6 and in some aspects, the first module 14 includes a frame 24 having side supports 26, 28 and intermediate supports 30 extending between the side supports 26, 28. In some constructions and in some aspects, the side supports 26, 28 include lower flanges 34, upper flanges 36, and web portions 38 extending between the lower and upper flanges 34, 36.

In the illustrated construction of FIGS. 1-6 and in some aspects, the lower flanges 34 define apertures 40 for receiving fasteners to secure the side supports 26, 28 to legs, tabletops, shop floors, and the like. Any conventional fastener can be employed to secure the side supports 26, 28 as just described, such as screws, nails, rivets, pins, posts, clips, clamps, inter-engaging elements, and any combination of such fasteners.

In some constructions and in some aspects, the upper flanges 36 also define apertures 40 for receiving fasteners to secure guide rails 42 (shown in FIG. 1) to the side supports 26, 28. In the illustrated construction of FIGS. 1-6 and in some aspects, the side supports 26, 28 have substantially similar shapes and sizes and the apertures 40 are similarly positioned along the lower and upper flanges 34, 36 so that the side supports 26, 28 are interchangeable, thereby simplifying the manufacture and assembly of the conveyor 10.

In some constructions and in some aspects, the web portions 38 of the side supports 26, 28 define lateral openings 46 for receiving elevator bodies 132 (described below). In the illustrated construction of FIGS. 1-6 and in some aspects, each of the web portions 38 defines two lateral openings 46. In other constructions and in other aspects, each of the side supports 26, 28 can define one, three, or more lateral openings 46 for receiving a corresponding number of elevator bodies 132.

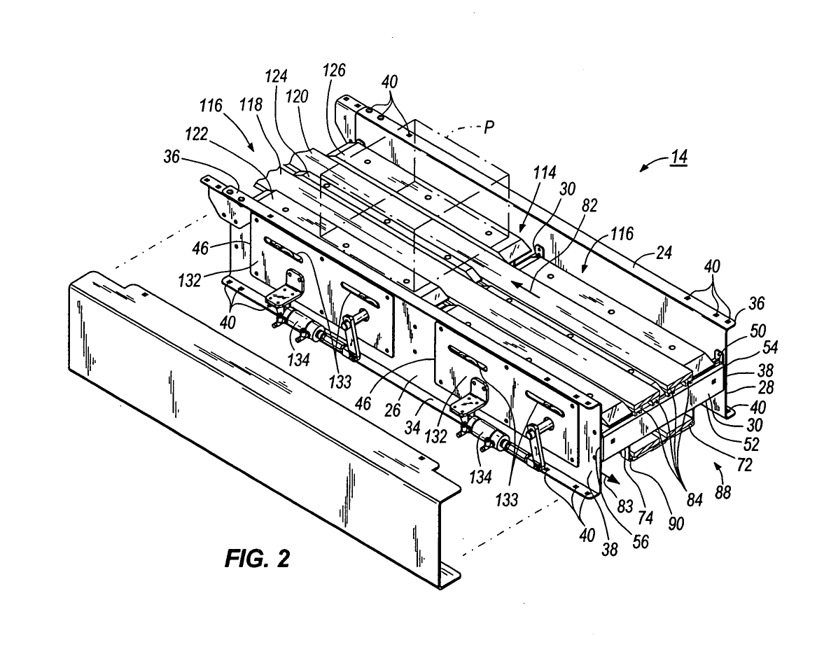

In the illustrated construction of FIGS. 2-6 and in some aspects, the first module 14 includes three intermediate supports 30 extending between the side supports 26, 28 and located at an upstream end of the first module 14, at a downstream end of the first module 14, and in a central portion of the first module 14 between the upstream and downstream ends. In other constructions and in other aspects, the first module 14 can include one, two, four, or more intermediate supports 30 extending between the side supports 26, 28 and located between the upstream and downstream ends.

As shown in FIGS. 2, 6, and 13-16, the intermediate supports 30 include upper surfaces 50, lower surfaces 52, and ends 54, 56. In some constructions and in some aspects, the upper surfaces 50 include couplers 60 having an outwardly extending tongue 62 and notches 64 extending through the upper surfaces 50 and located on opposite sides of the tongues 62.

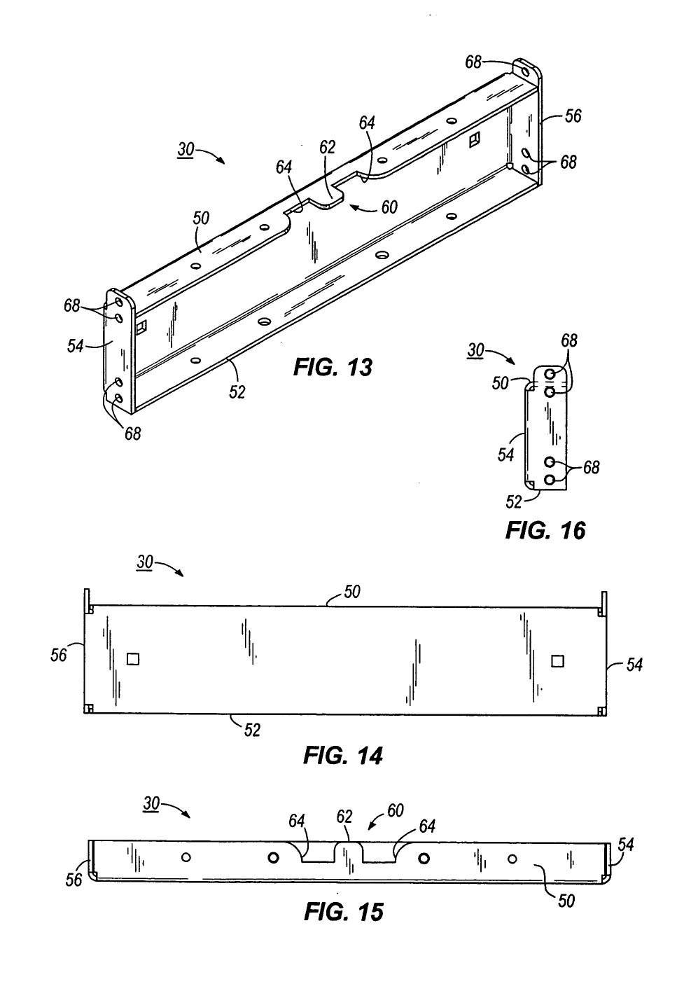

In the illustrated construction of FIGS. 13-16 and in some aspects, each of the ends 54, 56 includes two pairs of mounting apertures 68 for securing the intermediate supports 30 in either of two orientations with respect to the side supports 26, 28. In these constructions and in these aspects, fasteners can secure the intermediate supports 30 to the side supports 26, 28 in a first orientation (shown in FIG. 6), in which the upper surfaces 50 of the intermediate supports 30 are spaced a first distance from an imaginary plane 70 extending through the upper flanges 36 of the side supports 26, 28, and in a second orientation, in which the upper surfaces 50 of the intermediate supports 30 are spaced a second, larger distance from the imaginary plane 70. In this manner, the first module 14 can be assembled in either of two configurations to support either of two differently sized chains. Moreover, in some constructions and in some aspects, the intermediate supports 30 can support either of the two differently sized chains so that the upper surfaces of the differently sized chains are spaced the same distance from the imaginary plane 70.

In other constructions and in other aspects, the intermediate supports 30 can include three or more pairs of mounting apertures 68 for mounting the intermediate supports 30 in three or more orientations with respect to the side supports 26, 28 so that the first module 14 of the conveyor 10 can be assembled in any one of three or more configurations to support any one of three or more differently sized chains. Any conventional fastener can be employed to secure the intermediate supports 30 as just described, such as screws, nails, rivets, pins, posts, clips, clamps, inter-engaging elements, and any combination of such fasteners.

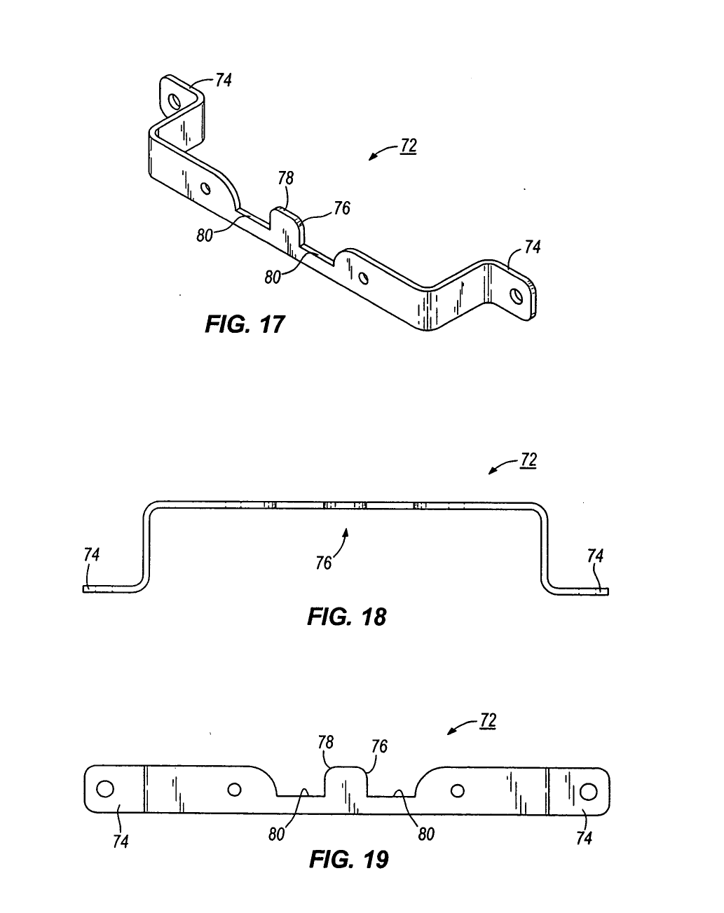

In some constructions and in some aspects, the first module 14 also includes conveyor return brackets 72 having outwardly extending flanges 74 and couplers 76 (shown in FIGS. 17-19) positioned between the flanges 74. In the illustrated construction of FIGS. 2 and 6, fasteners extend through apertures in the flanges 74 and secure the conveyor return brackets 72 to the lower surfaces 52 of the intermediate supports 30. Any conventional fastener can be employed to secure the flanges 74 as just described, such as screws, nails, rivets, pins, posts, clips, clamps, inter-engaging elements, and any combination of such fasteners.

In some aspects and in some constructions, the couplers 76 include outwardly extending tongues 78 and notches 80 extending through the conveyor brackets 72 and located on opposite sides of the tongues 78. In the illustrated construction of FIGS. 2, 6, and 17-19 and in some aspects, the couplers 76 of the conveyor return brackets 72 are substantially similar to the couplers 60 of the intermediate supports 30. In this manner and as explained in greater detail below, couplers 106 of channel sections 90 are securable to both the couplers 60 of the intermediate supports 30 and the couplers 76 of the conveyor return brackets 72.

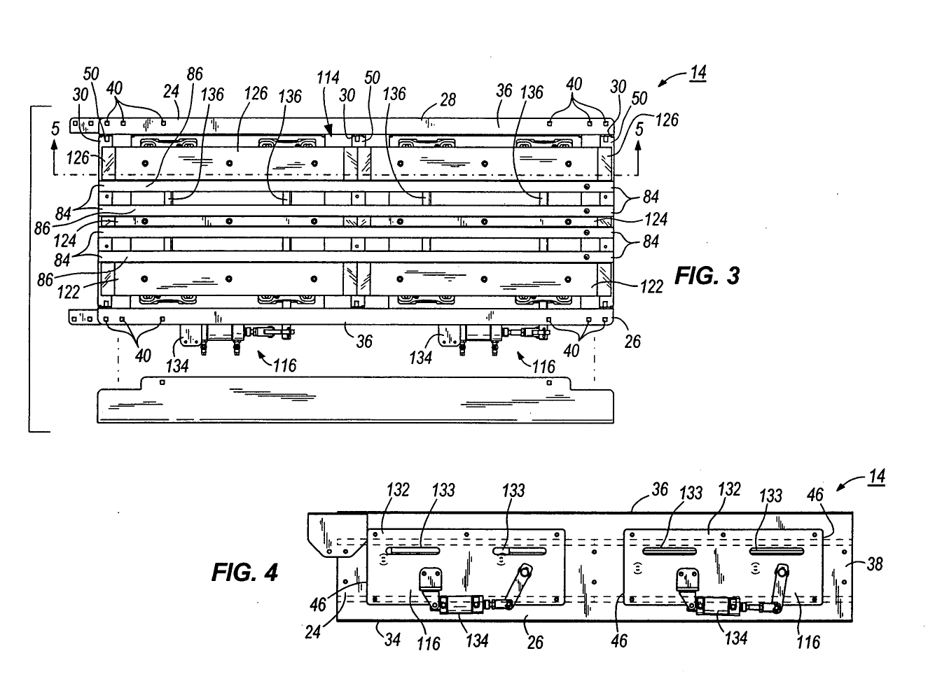

In the illustrated construction of FIGS. 2-4 and 6 and in some aspects, the first module 14 includes tracks 84, which extend between two or more intermediate supports 30 and support the chain 20. In some constructions and in some aspects, upper surfaces of the tracks 84 prevent the chain 20 from sagging and define relatively smooth wear surfaces 86 (shown in FIG. 3). Any conventional fastener can be employed to secure the tracks 84 to the intermediate supports 30 as just described, such as screws, nails, rivets, pins, posts, clips, clamps, inter-engaging elements, and any combination of such fasteners.

In some constructions and in some aspects, the chain 20 is an endless member. In these constructions and in these aspects, the first module 14 also includes a belt return area 88. In the illustrated construction of FIG. 2 and in these aspects, the chain 20 moves across the tracks 84 in a travel direction (represented by arrow 82) and moves through the belt return area 88 in an opposite travel direction (represented by arrow 83).

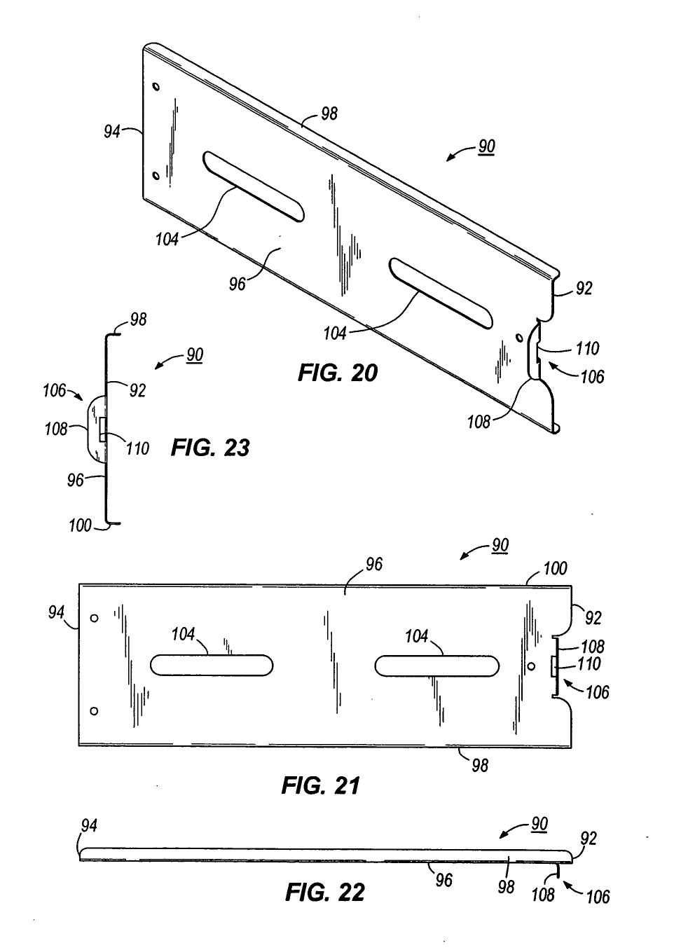

In the illustrated construction of FIG. 2 and in some aspects, the belt return area 88 includes a number of chutes or channel sections 90 supported on and secured to the conveyor return brackets 72. As shown in FIGS. 20-23, the channel sections 90 include first and second ends 92, 94, a base section 96, sides 98, 100, and openings 104 extending through the base section 96 so that dust and debris can pass through the channel sections 90.

In the illustrated construction and in some aspects, the first end 92 includes a coupler 106 having an outwardly extending lip 108, which defines an opening 110. To secure the channel sections 90 to the conveyor return brackets 72, an operator engages the tongue 78 of a conveyor return bracket 72 in the opening 110 of a channel section 90 and pivots the channel section 90 with respect to the conveyor return bracket 72, lockingly engaging the channel section 90 and the conveyor return bracket 72. In the illustrated construction of FIGS. 2, 6, and 20-23 and in some aspects, the second end 94 defines apertures for receiving fasteners to secure the second end 94 to a second conveyor bracket 72. Any conventional fastener can be employed to secure the second end 94 as just described, such as screws, nails, rivets, pins, posts, clips, clamps, inter-engaging elements, and any combination of such fasteners.

In the illustrated construction of FIG. 6 and in some aspects, wear inserts 112 are secured to the base sections 96 of the channel sections 90. In these constructions and in these aspects, the wear inserts 112 support the chain 20 and minimize friction and wear between the chain 20 and the channel sections 90.

In some constructions and in some aspects, the first module 14 also includes an accumulation station 114 and elevator assemblies 116 located in the accumulation station 114. In the illustrated construction of FIGS. 1-9 and in some aspects, the first module 14 includes two elevator assemblies 116. In other constructions and in other aspects, the first module 14 can include one, three, or more elevator assemblies 116. In operation, the elevator assemblies 116 are operable to remove products P from the chain 20 to alter the spacing between products P or to accumulate a number of products P in the accumulation station 114.

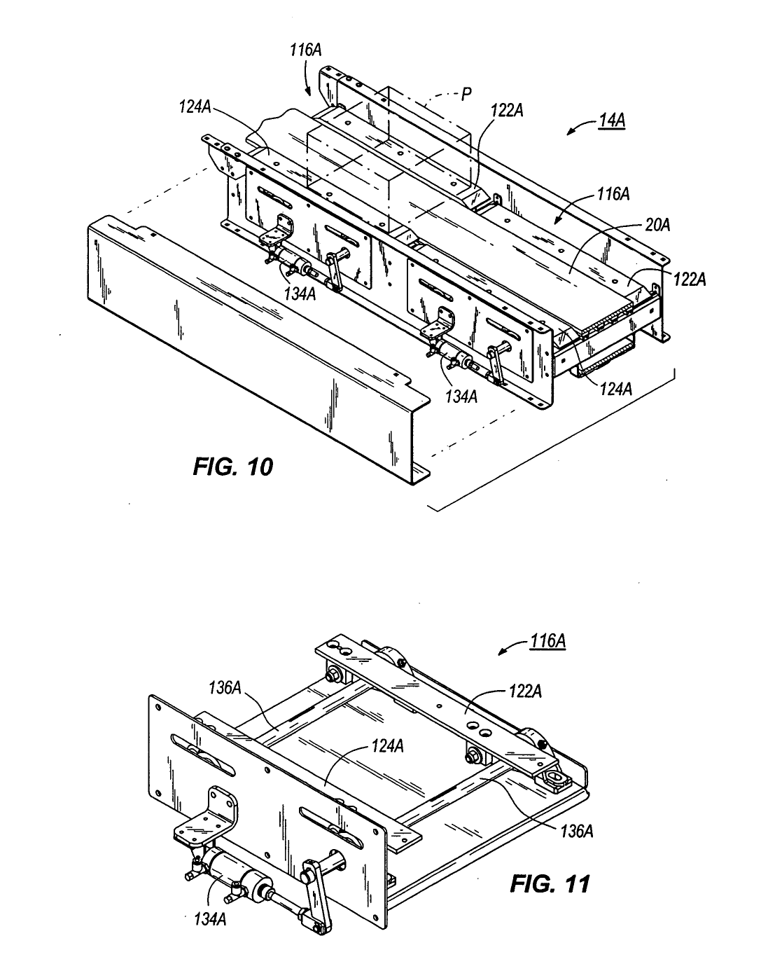

In the illustrated construction of FIGS. 2-9 and in some aspects, the chain 20 includes a first section 118 and a second section 120 and each of the elevator assemblies 116 include three shuttles 122, 124, 126. In these constructions and in these aspects, the first section 118 of the chain 20 is supported on the first module 14 between shuttles 122, 124 and the second section 120 is supported on the first module 14 between shuttles 124, 126. In other constructions and as explained below, the elevator assemblies 116 can include one, two, four or more shuttles positioned between or adjacent conveyor sections 118, 120. In some constructions and in some aspects, the conveyor 10 can include a chain 20 having a single section (as shown in FIG. 1 and FIG. 10) or a chain having three or more sections and the elevator assemblies 116 can include shuttles positioned between or adjacent to the conveyor sections.

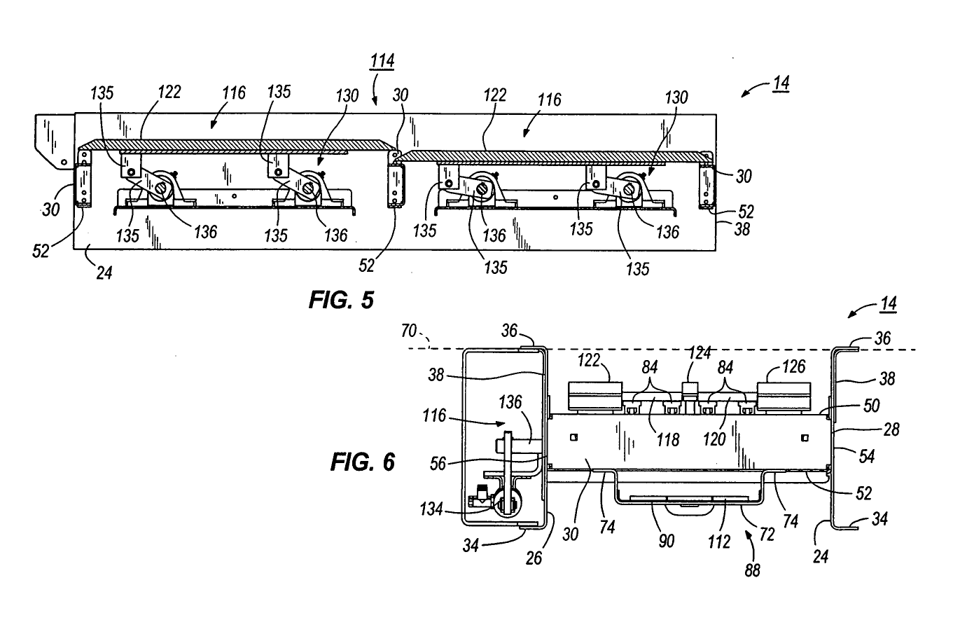

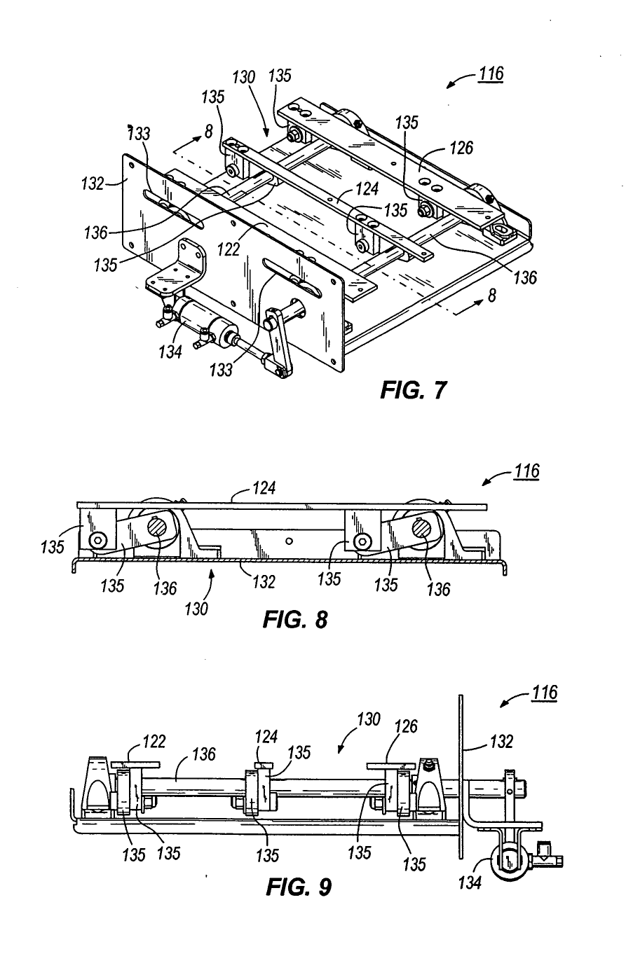

With reference to FIGS. 5 and 6, the elevator assemblies 116 also include a drive assembly 130 having a body 132. The bodies 132 are removeably inserted in lateral openings 46 of the side supports 26, 28 and are supported between the intermediate supports 30. To facilitate transportation of the elevator bodies 132 and to simplify assembly of the first module 14, the bodies 132 can also include handles 133 (shown in FIG. 7).

In the illustrated construction of FIGS. 2-4, 5-7 and, 9 and in some aspects, each of the bodies 132 includes at least one actuator 134 (e.g., an air cylinder, a pneumatic cylinder, a servo motor, a solenoid, etc.), which can be located on an external side of the bodies 132 to facilitate maintenance. In these constructions and in these aspects, two drive shafts 136 extend through the body 132 to the actuator 134. Links 135 connect the undersides of the shuttles 122, 124, 126 and the drive shafts 136. In this manner, the actuators 134 are operable to pivot one or both of the drive shafts 136 about their axes, thereby moving the shuttles 122, 124, 126 between a first or recessed position, in which the upper surfaces of the shuttles 122, 124, 126 are substantially aligned with the upper surface of the chain 20, and a second or raised position, in which the upper surfaces of the shuttles 122, 124, 126 are spaced above the upper surface of the chain 20. In other constructions and in other aspects, the shuttles 122, 124, 126 are moveable between a first position, in which the upper surfaces of the shuttles 122, 124, 126 are recessed below the upper surface of the chain 20, and a second or raised position, in which the upper surfaces of the shuttles 122, 124, 126 are spaced above the upper surface of the chain 20.

During operation of the conveyor 10, the chain 20 moves products P in the travel direction 82. As products P move across the accumulation station 114, the elevator drive assemblies 130 are selectively activated to move the shuttles 122, 124, 126 between first and second positions and to selectively remove products P from the chain 20, thereby sorting products P, altering the flow of products P through the first module 14, and/or accumulating a number of products P in the accumulation station 114.

FIGS. 10 and 11 illustrate an alternate construction of the first module 14A according to the present invention. The first module 14A in FIGS. 10 and 11 is similar in many ways to the illustrated constructions of FIGS. 1-9 described above. Accordingly, with the exception of mutually inconsistent features and elements between the constructions of FIGS. 10 and 11 and the construction of FIGS. 1-9, reference is hereby made to the description above accompanying the construction of FIGS. 1-9 for a more complete description of the features and elements (and the alternatives to the features and elements) of the construction of FIGS. 10 and 11. Features and elements in the construction of FIGS. 10 and 11 corresponding to features and elements in the construction of FIGS. 1-9 are identified by the same reference number and the letter “A”.

In the illustrated construction of FIGS. 10 and 11 and in some aspects, the chain 20A includes a single section and each of the elevator assemblies 116A include two shuttles 122A, 124A located on opposite sides of the belt 20A to guide the chain 20A on the first module 14A. In these constructions and in these aspects, the actuator 134A is operable to pivot one or both of the drive shafts 136A about their axes, thereby moving the shuttles 122A, 124A, between a first or recessed position, in which the upper surfaces of the shuttles 122A, 124A are substantially aligned with the upper surface of the chain 20A, and a second or raised position, in which the upper surfaces of the shuttles 122A, 124A are spaced above the upper surface of the chain 20A. In other constructions and in other aspects, the shuttles 122A, 124A are moveable between a first position, in which the upper surfaces of the shuttles 122A, 124A are recessed below the upper surface of the chain 20A (not shown), and a second or raised position, in which the upper surfaces of the shuttles 122A, 124A are spaced above the upper surface of the chain 20.

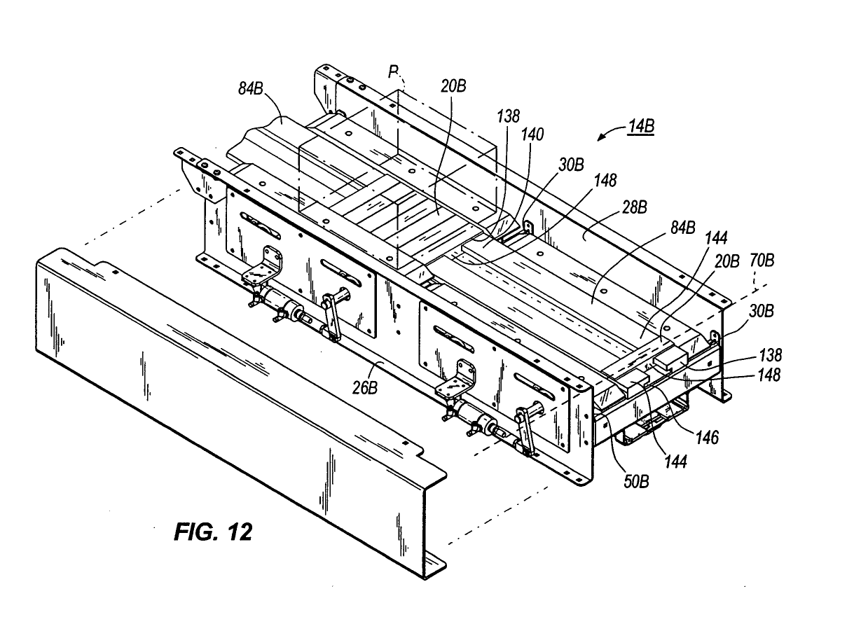

FIG. 12 illustrates another alternate construction of the first module 14B according to the present invention. The first module 14B in FIG. 12 is similar in many ways to the illustrated constructions of FIGS. 1-11 described above. Accordingly, with the exception of mutually inconsistent features and elements between the constructions of FIG. 12 and the construction of FIGS. 1-11, reference is hereby made to the description above accompanying the constructions of FIGS. 1-11 for a more complete description of the features and elements (and the alternatives to the features and elements) of the construction of FIG. 12. Features and elements in the construction of FIG. 12 corresponding to features and elements in the constructions of FIGS. 1-11 are identified by the same reference number and the letter “B”.

In the illustrated construction of FIG. 12 and in some aspects, the first module 14B includes tracks 84B extending across and between intermediate supports 30B. The tracks 84B have first and second ends 138, 140 and define apertures (not shown) for receiving fasteners to secure the tracks 84B to the intermediate supports 30B.

Any conventional fastener can be employed to secure the tracks 84B to the intermediate supports 30B as just described, such as screws, nails, rivets, pins, posts, clips, clamps, inter-engaging elements, and any combination of such fasteners. For example, in some constructions and in some aspects, threaded fasteners are used to secure the first and second ends 138, 140 of the tracks 84B to one or more intermediate supports 30B. In the illustrated construction and in some aspects, Z-shaped clips are used to secure the first ends 138 and/or the second ends 140 of the tracks 84B to the intermediate supports 30B and to allow limited relative movement between the tracks 84B and the intermediate supports 30B caused by thermal expansion of the tracks 84B and other elements of the conveyor 10.

As shown in FIG. 12, the tracks 84B include inwardly extending rails 144. Together, the rails 144 define guide slots 146, which extend along each of the tracks 84B between upstream and downstream ends of the tracks 84B.

As shown in FIG. 12, a chain 20B is supported on the tracks 84B and is moveable along the tracks 84B in the travel direction 82B. The chain 20B of the illustrated construction of FIG. 12 includes a follower 148, which extends downwardly from an upper portion of the chain 20B and is engageable in the guide slot 146 between the rails 144. In these constructions and in these aspects, the rails 144 maintain the chain 20B in position on the tracks 84B.

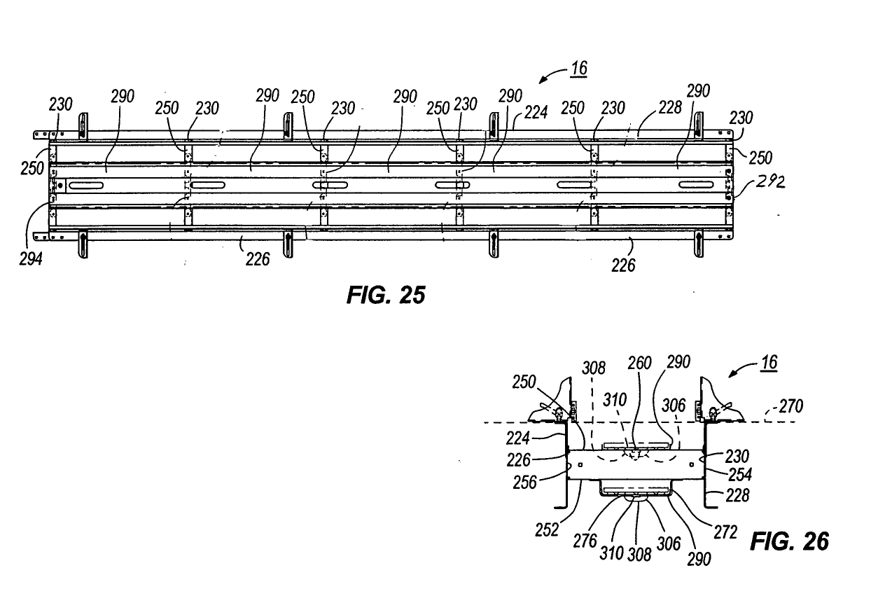

As mentioned above, the conveyor 10 can also include a second module 16 for supporting the chain 20 or a portion of the chain 20 and for moving products P between two or more locations. In the illustrated construction of FIGS. 1 and 24-26 and in some aspects, the second module 16 includes a frame 224 having side supports 226, 228 and intermediate supports 230 extending between the side supports 226, 228.

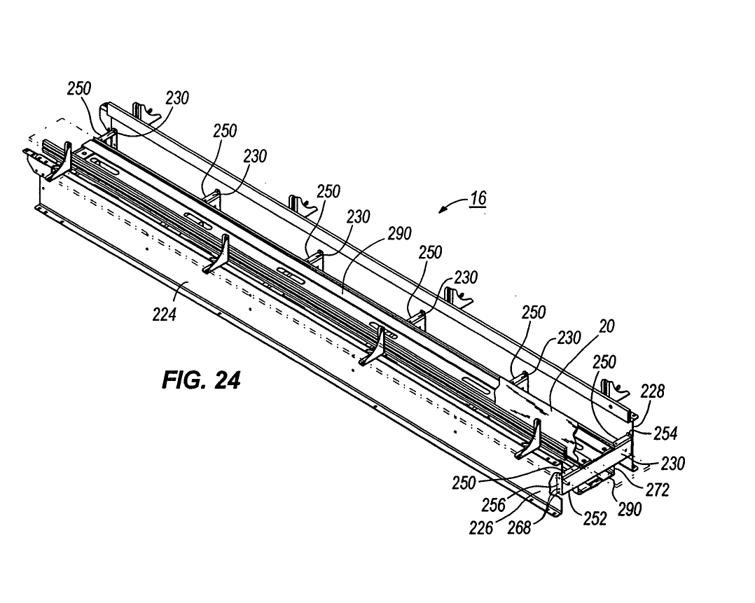

As shown in FIGS. 24-26, the intermediate supports 230 include upper surfaces 250, lower surfaces 252, ends 254, 256, and couplers 260 positioned on the upper surfaces 250. In the illustrated construction of FIGS. 24-26 and in some aspects, each of the ends 254, 256 includes two pairs of mounting apertures 268 for securing the intermediate supports 230 in either of two orientations with respect to the side supports 226, 228. In these constructions and in these aspects, fasteners can secure the intermediate supports 230 to the side supports 226, 228 in a first orientation, in which the upper surfaces 50 of the intermediate supports 230 are spaced a first distance from an imaginary plane 270 (shown in FIG. 26) extending through the upper ends of the side supports 226, 228, and in a second orientation, in which the upper surfaces 250 of the intermediate supports 230 are spaced a second, larger distance from the imaginary plane 270. In this manner, the second module 16 can be assembled in either of two configurations to support either of two differently sized chains. In other constructions and in other aspects, each of the ends 254, 256 can include three or more pairs of mounting apertures 268 for securing the intermediate supports 230 in any one of three or more orientations with respect to the side supports 226, 228.

In some constructions and in some aspects, the second module 16 also includes conveyor return brackets 272. In the illustrated construction of FIGS. 24-26, the conveyor return brackets 272 are secured to the lower surfaces 252 of the intermediate supports 230 and include couplers 276.

In some constructions and in some aspects, the second module 16 also includes chutes or channel sections 290 having first and second ends 292, 294. The first ends 292 include couplers 306 having an outwardly extending lip 308 defining an opening 310. In the illustrated construction of FIGS. 24-26 and in some aspects, channel sections 290 extend between and across the intermediate supports 230 to support an upper portion of the chain 20. Other channel sections 290 extend across and between conveyor return brackets 272 to support a return or lower portion of the chain 20.

In the illustrated construction of FIGS. 24-26 and in some aspects, the couplers 276 of the conveyor return brackets 272 are substantially similar to the couplers 260 of the intermediate supports 230. In this manner, the couplers 306 of channel sections 290 are securable to both the couplers 260 of the intermediate supports 230 and the couplers 276 of the conveyor return brackets 272.

To secure the channel sections 290 to the conveyor return brackets 272, an operator lockingly engages the coupler 276 of a conveyor return bracket 272 and the coupler 306 of a channel section 290. To secure the channel sections 290 to the intermediate supports 230, an operator lockingly engages the coupler 260 of a intermediate support 230 and the coupler 306 of a channel section 290.

In the illustrated construction of FIGS. 24-26 and in some aspects, the second end 294 defines apertures for receiving fasteners to secure the second ends 294 of the channels 290 to a conveyor return bracket 272 or an intermediate support 230. Any conventional fastener can be employed to secure the second end 294 as just described, such as screws, nails, rivets, pins, posts, clips, clamps, inter-engaging elements, and any combination of such fasteners.

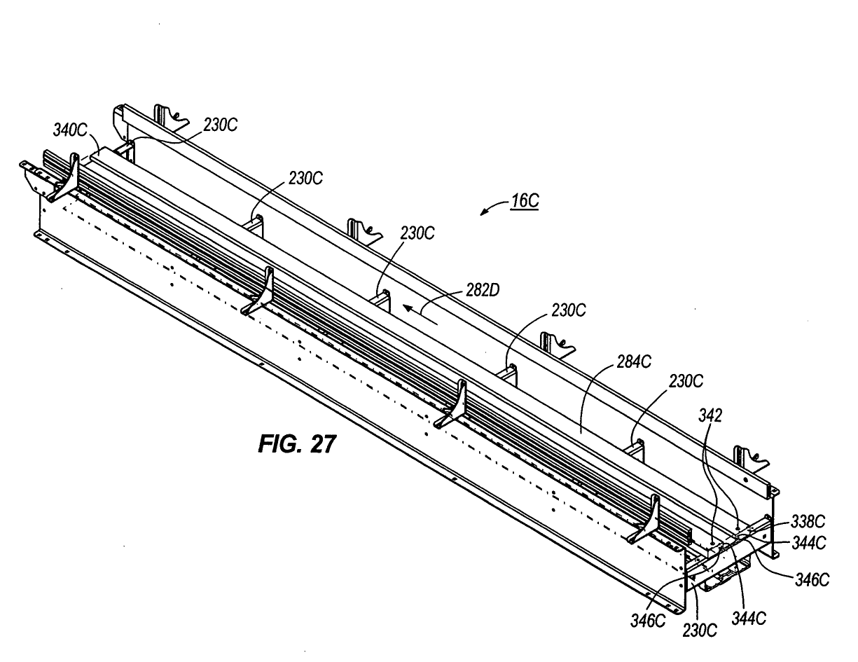

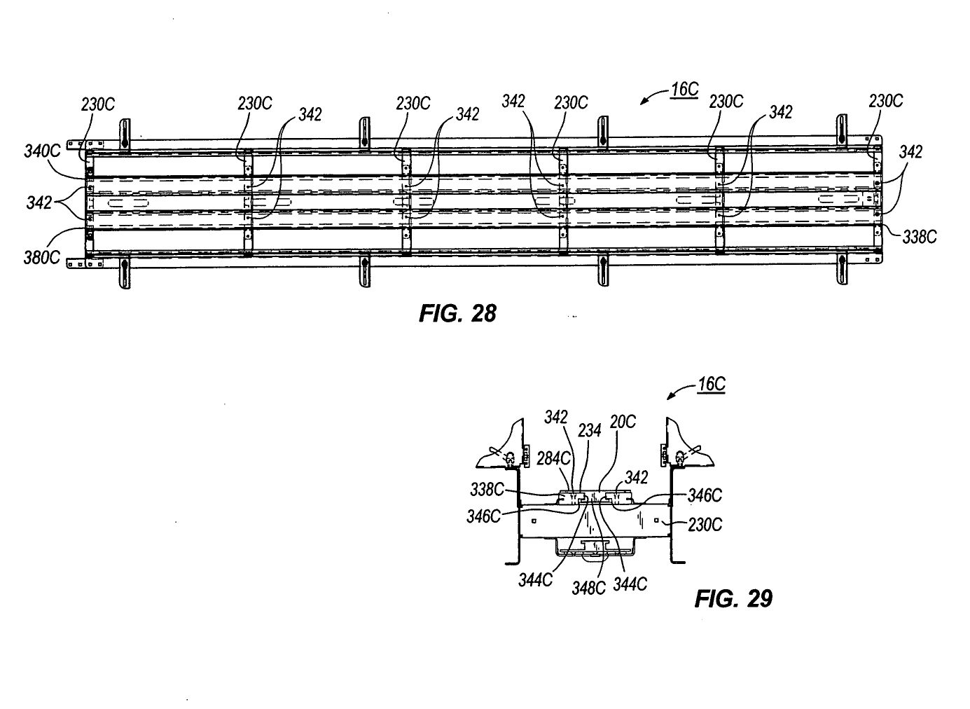

FIGS. 27-29 illustrate another construction of the second module 16C according to the present invention. The second module 16C in FIGS. 27-29 is similar in many ways to the illustrated constructions of FIGS. 1-26 described above. Accordingly, with the exception of mutually inconsistent features and elements between the constructions of FIGS. 27-29 and the construction of FIGS. 1-26, reference is hereby made to the description above accompanying the construction of FIGS. 1-26 for a more complete description of the features and elements (and the alternatives to the features and elements) of the construction of FIGS. 27-29. Features and elements in the construction of FIGS. 27-29 corresponding to features and elements in the construction of FIGS. 1-26 are identified by the same reference number and the letter “C”.

In the illustrated construction of FIGS. 27-29 and in some aspects, the second module 16C includes tracks 284C, which extend across and between intermediate supports 230C. The tracks 284C have first and second ends 338C, 340C and define apertures 342 for receiving fasteners to secure the tracks 284C to the intermediate supports 230C. Any conventional fastener can be employed to secure the tracks 284C to the intermediate supports 230C as just described, such as screws, nails, rivets, pins, posts, clips, clamps, inter-engaging elements, and any combination of such fasteners. For example, in some constructions and in some aspects, threaded fasteners are used to secure the first and second ends 338C, 340C of the tracks 284C to one or more intermediate supports 230C. In the illustrated construction and in some aspects, Z-shaped clips are used to secure the first ends 338C and/or the second ends 340C of the tracks 284C to the intermediate supports 230C and to allow limited relative movement between the tracks 284C and the intermediate supports 230C caused by thermal expansion of the tracks 284C and other elements of the conveyor 10.

In the illustrated construction of FIGS. 27-29 and in some aspects, the tracks 284C include inwardly extending rails 344C. Together, the rails 344C define guide slots 346C, which extend along each of the tracks 284C between upstream and downstream ends of the tracks 284C.

As shown in FIG. 29, a chain 20C is supported on the tracks 284C and is moveable along the tracks 284C in the travel direction 282C. The chain 20C of the illustrated construction of FIG. 29 includes a follower 348C, which extends downwardly from an upper portion of the chain 20C and is engageable in the guide slot 346C between the rails 344C. In these constructions and in these aspects, the rails 344C maintain the chain 20C in position on the tracks 284C.

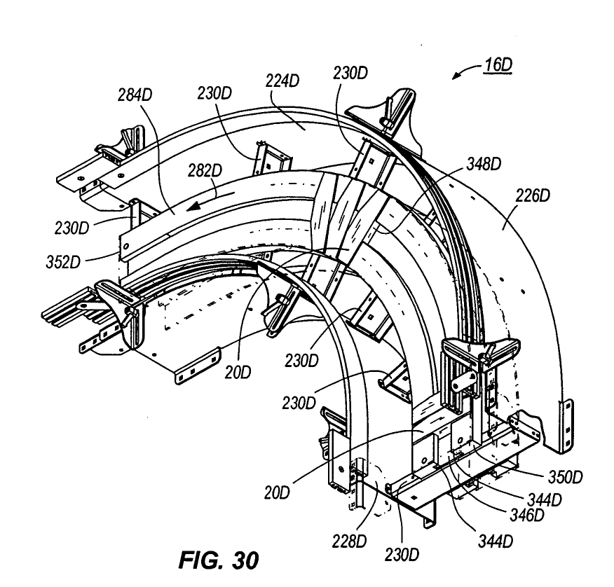

FIG. 30 illustrates another construction of the second module 16D according to the present invention. The second module 16D in FIG. 30 is similar in many ways to the illustrated constructions of FIGS. 1-29 described above. Accordingly, with the exception of mutually inconsistent features and elements between the constructions of FIG. 30 and the constructions of FIGS. 1-29, reference is hereby made to the description above accompanying the constructions of FIGS. 1-29 for a more complete description of the features and elements (and the alternatives to the features and elements) of the construction of FIG. 30. Features and elements in the construction of FIG. 30 corresponding to features and elements in the constructions of FIGS. 1-29 are identified by the same reference number and the letter “D”.

In the illustrated construction of FIG. 30 and in some aspects, the second module 16D is a curved or angled module. As shown in FIG. 30, the second module 16D includes a frame 224D having side supports 226D, 228D and intermediate supports 230D. Tracks 284D extend across and between intermediate supports 230D and supports a chain 20D, which is moveable along the tracks 284D in a travel direction 282D between an upstream side 350D and a downstream side 352D of the second module 16D.

In the illustrated construction of FIG. 30 and in some aspects, the downstream side 352D of the second module 16D is oriented at an angle of about 90 degrees with respect to the upstream side 350D of the second module 16D. In other constructions and in other aspects, the downstream side 352D of the second module 16D can be oriented at an angle of between about one degree and about 89 degrees with respect to the upstream side 350D of the second module 16D.

As shown in FIG. 30, the tracks 284D include inwardly extending rails 344D. Together, the rails 344D define a guide slot 346D, which extends along the tracks 284D between upstream and downstream ends 350D, 352D of the tracks 284D. The chain 20D of the illustrated construction of FIG. 30 includes a follower 348D, which extends downwardly from an upper portion of the chain 20D and is engageable in the guide slot 346D between the rails 344D. In these constructions and in these aspects, the rails 344D maintain the chain 20D in position on the tracks 284D.

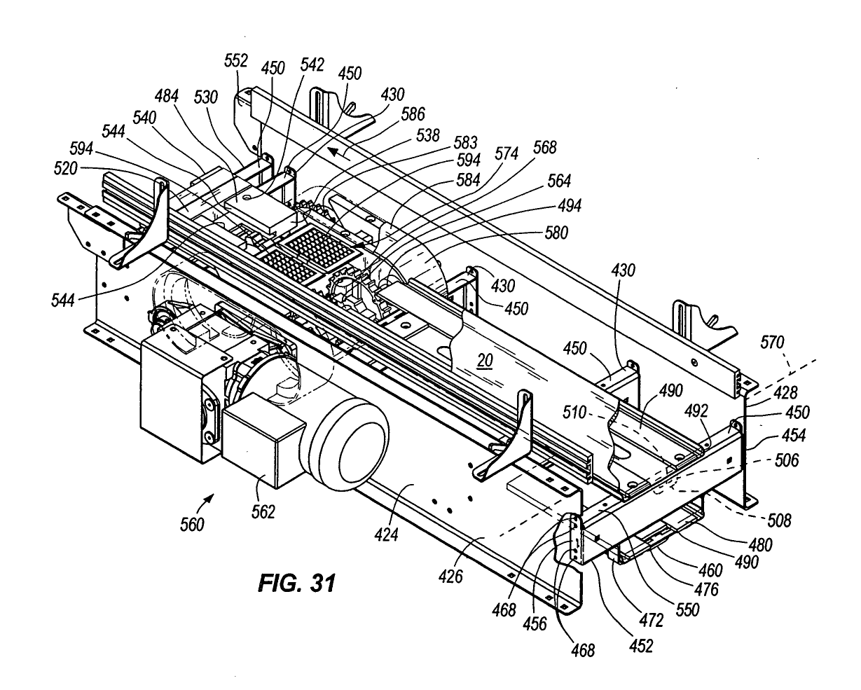

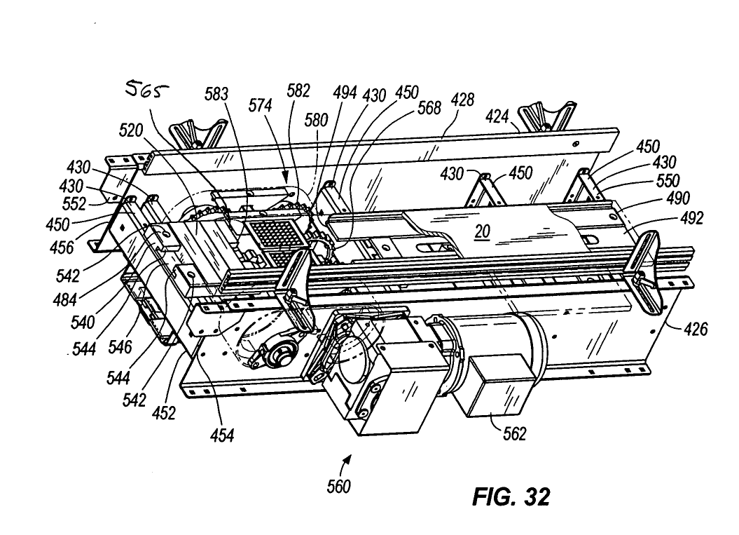

As mentioned above, the conveyor 10 can also include a third module 18. In the illustrated construction of FIGS. 1, 31, and 32 and in some aspects, the third module 18 includes a frame 424 having side supports 426, 428 and intermediate frame supports 430 extending between the side supports 426, 428. As shown in FIGS. 31 and 32, the frame 424 defines upstream and downstream ends 550, 552 for supporting chains 20, 520 (portions of which are shown in FIGS. 31 and 32), respectively. In other constructions and in other aspects, the frame 424 can support one or more chains extending across the upstream and downstream ends 550, 552.

In some embodiments and in some aspects, the intermediate supports 430 include upper surfaces 450, lower surfaces 452, ends 454, 456, and outwardly extending couplers 460. In these constructions and in these aspects, each of the ends 454, 456 includes two pairs of mounting apertures 468 for securing the intermediate supports 430 in either of two orientations with respect to the side supports 426, 428. In these constructions and in these aspects, fasteners can secure the intermediate supports 430 to the side supports 426, 428 in a first orientation, in which the upper surfaces 450 of the intermediate supports 430 are spaced a first distance from an imaginary plane 570 extending through upper ends of the side supports 426, 428, and in a second orientation, in which the upper surfaces 450 of the intermediate supports 430 are spaced a second, larger distance from the imaginary plane 570. In this manner, the third module 18 of the conveyor 10 can be assembled in either of two configurations to support either of two differently sized chains. Moreover, in some constructions and in some aspects, the intermediate supports 430 can support either of the two differently sized chains so that the upper surfaces of the differently sized chains are spaced the same distance from the imaginary plane 570.

For example, in the illustrated construction of FIGS. 31 and 32 and in some aspects, two intermediate supports 430 are secured to the side supports 426, 428 in a first orientation to support belt 20 and three supports are secured to the side supports 426, 428 in a second orientation to support belt 520 in a second orientation. In these constructions and in these aspects, the upper surfaces of two differently sized belts or chains (i.e., chain 20 and chain 520) can be substantially aligned.

In other constructions and in other aspects, the intermediate supports 430 can include three or more pairs of mounting apertures 468 for mounting the intermediate supports 430 in three or more orientations with respect to the side supports 426, 428. Any conventional fastener can be employed to secure the intermediate supports 430 as just described, such as screws, nails, rivets, pins, posts, clips, clamps, inter-engaging elements, and any combination of such fasteners.

In some aspects and in some constructions, the third module 18 also includes conveyor return brackets 472, which can be secured to the lower surfaces 452 of the intermediate supports 430 and can include couplers 476.

In some constructions and in some aspects, the third module 18 also includes chutes or channel sections 490 having first and second ends 492, 494. The first ends 492 include couplers 506 having an outwardly extending lip 508 defining an opening 510. In the illustrated construction of FIGS. 31 and 32 and in some aspects, a channel section 490 extends between and across the intermediate supports 430 to support an upper portion of chain 20. Another channel section 490 extends across and between conveyor return brackets 472 to support a return or lower portion of the chain 20. In the illustrated embodiment of FIGS. 31 and 32 and in some aspects, the couplers 460 of the intermediate supports 430 and the couplers 476 of the conveyor return brackets 472 are substantially similar so that the channels 490 can be connected to the intermediate supports 430 and/or the conveyor return brackets 472.

In some constructions and in some aspects, the third module 18 can include tracks 484, which extend across and between intermediate supports 430. In the illustrated construction of FIGS. 31 and 32, the tracks 484 extend across the downstream end 552 of the frame 524 and support chain 520. The tracks 484 have first and second ends 538, 540 and define apertures 542 for receiving fasteners to secure the tracks 484 to the intermediate supports 430.

Any conventional fastener can be employed to secure the tracks 484 to the intermediate supports 430 as just described, such as screws, nails, rivets, pins, posts, clips, clamps, inter-engaging elements, and any combination of such fasteners. For example, in some constructions and in some aspects, threaded fasteners are used to secure the first and second ends 538, 540 of the tracks 484 to one or more intermediate supports 430. In the illustrated construction and in some aspects, Z-shaped clips are used to secure the first ends 538 and/or the second ends 540 of the tracks 484 to the intermediate supports 430 and to allow limited relative movement between the tracks 484 and the intermediate supports 430 caused by thermal expansion of the tracks 484 and other elements of the conveyor 10.

As shown in FIGS. 31 and 32, the tracks 484 include inwardly extending rails 544. Together, the rails 544 define guide slots 546, which extend along each of the tracks 484 between upstream and downstream ends of the tracks 484.

The chain 520 of the illustrated construction of FIGS. 31 and 32 includes a follower 548, which extends downwardly from an upper portion of the chain 520 and is engageable in the guide slot 546 between the rails 544. In these constructions and in these aspects, the rails 544 maintain the chain 520 in position on the track 484.

In some constructions and in some aspects, the third module 18 includes a drive assembly 560. In the illustrated construction of FIGS. 31 and 32 and in some aspects, the drive assembly 560 includes an actuator 562 (e.g., an electric motor, an air motor, an internal combustion engine, etc.) and a drive shaft 564. Drive wheels 568 are secured to the drive shaft 564 for rotation with the drive shaft 564 about the drive shaft axis. The chain 20 extends across and is drivingly engageable with drive wheels 568 so that rotation of the drive shaft 564 causes the chain 20 to move in the first travel direction 482. As shown in FIG. 1, an opposite end of the chain 20 extends across and is supported on an idler shaft 592.

In some embodiments and in some aspects, the third module 18 includes a transfer station 574 defined between chains 20, 520. In the illustrated construction of FIGS. 31 and 32 and in some aspects, the third module 18 includes guide plates 594 located in the transfer station 574 between the belts 20, 520. In these constructions and in these aspects, the guides 594 direct products P between chains 20, 520 and across the transfer station 574. In other constructions and in other aspects, other guides, including rollers, slides, chutes, and the like can also or alternately be used to direct products P across the transfer station 574.

In some constructions and in some aspects, products P can accumulate and/or become stuck in the transfer station 574. In the illustrated construction of FIGS. 31 and 32 and in some aspects, the third module 18 also includes intermediate conveyors 580 positioned between the conveyors 20, 520 to transfer products between chains 20, 520 and across the transfer station 574.

In the illustrated construction of FIGS. 31 and 32, the intermediate conveyors 580 can include drive wheels 582 fixedly coupled to the drive shaft 564 or drive shaft 565. Chains or belts 584 extend across and between the drive wheels 582 and idler wheels 583 so that rotation of the drive shaft 564 moves the intermediate conveyors 580 in a travel direction 586. In these constructions and in these aspects, the chains 584 of the intermediate conveyors 580 move products P between the chains 20, 520 and prevent the products P from accumulating or becoming stuck in the transfer station 574.

In some constructions and in some aspects, a number of common elements are used in the first, second, and third modules 14, 16, 18 to simplify assembly of the first, second, and third modules 14, 16, 18. For example, in the illustrated construction and in some aspects, side supports 26, 28 of the first module 14, side supports 226, 228 of the second module 16, and side supports 426, 428 of the third module 18 are substantially similar and are interchangeable, the intermediate supports 30 of the first module 14, the intermediate supports 230 of the second module 16, and the intermediate supports 430 of the third module are substantially similar and are interchangeable, the conveyor return brackets 72 of the first module 14, the conveyor return bracket 272 of the second module 16, and the conveyor return bracket 472 of the third module 18 are substantially similar and are interchangeable, and the channel sections 90 of the first module 14, the channel sections 290 of the second module 16, and the channel sections 490 of the third module 18 are substantially similar and are interchangeable.

Various alternatives and constructions are contemplated as being within the scope of the following claims particularly pointing out and distinctly claiming the subject matter regarded as the invention. For example, while reference is made herein to constructions of the conveyor 10 in which the conveyor 10 includes one each of the first module 14, the second module 16, and the third module 18, it should be understood that in other constructions and in other aspects the conveyor 10 can also or alternately include or be reassembled to include one or more of the above-described modules 14, 14A, 14B, 16C, 16D, 18.

What is claimed is:

1. A conveyor system for carrying products, the conveyor system comprising:
a frame;
a conveyor supported on the frame for movement in a travel direction relative to the frame; and
an elevator assembly supported on the frame and including a shuttle positioned adjacent to the belt, the shuttle including an upper surface and being moveable relative to the frame between a first position, in which the upper surface is positioned to allow product to travel along the conveyor, and a second position, in which the upper surface is spaced a distance from the conveyor in a direction substantially normal to the travel direction to remove product from the conveyor.

2. The conveyor system of claim 1 wherein when the shuttle is in the first position the upper surface is substantially aligned with the conveyor.

3. The conveyor system of claim 1 wherein when the shuttle is in the first position the upper surface is recessed from the conveyor.

4. The conveyor system of claim 1 wherein the shuttle comprises a first section and a second section, the first and second sections being positioned on opposite sides of the conveyor.

5. The conveyor system of claim 1 wherein the conveyor includes a first section and a second section, and wherein the elevator assembly includes a supplemental shuttle positioned between the first and second sections of the conveyor.

6. The conveyor system of claim 1 wherein the frame defines an opening, and wherein the elevator assembly is a modular element insertable into the frame through the opening.

7. The conveyor system of claim 1 wherein the elevator assembly further comprises a drive mechanism to move the shuttle between the first and second positions.

8. The conveyor system of claim 1 further comprising a second elevator assembly positioned adjacent the elevator assembly

9. A frame assembly for carrying a conveyor belt, the frame assembly comprising:
a pair of side supports; and
an intermediate support extending between the side supports, the intermediate support having a surface and being securable to the side supports in a first orientation to support a first belt and a second orientation to support a second belt.

10. The frame assembly of claim 9 wherein the surface of the intermediate support includes a coupler comprising an outwardly extending tongue and notches extending through the surface and located on opposite sides of the tongue.

11. The frame assembly of claim 9 wherein the intermediate support includes a second surface and further comprising a return bracket for attachment to the second surface of the intermediate support, the return bracket defining a return path for the belt and including a coupler comprising an outwardly extending tongue and notches extending through the return bracket and located on opposite sides of the tongue.

12. The frame assembly of claim 11 further comprising a chute coupled to the return bracket for supporting the belt wherein at least one end of the chute includes a chute coupler comprising an outwardly extending lip defining an opening.

13. The frame assembly of claim 9 wherein the side supports include at least one opening for receiving an assembly.

14. The frame assembly of claim 9 wherein two or more intermediate supports extend between the side supports, the frame assembly further comprising a track extending between the intermediate supports for supporting the belt.

15. The frame assembly of claim 14 wherein the track comprises a chute defining a channel for receiving the belt.

16. The frame assembly of claim 15 wherein at least one end of the chute includes a coupler comprising an outwardly extending lip defining an opening.

17. The frame assembly of claim 14 wherein the track includes inwardly extending rails, the rails defining guide slots extending a length of the track, the guide slots for receiving a follower portion of the belt.

18. A frame assembly for carrying a conveyor belt, the frame assembly comprising:
first and second side supports;
two or more intermediate supports positionable between the first and second side supports, each having a first surface and a second surface opposite the first surface, the first surface including a forwardly extending tongue and defining notches on opposite sides of the tongue; and
a chute having a leading edge and a trailing edge, the leading edge including a lip defining an opening, and the chute securable to the intermediate supports.

19. The frame assembly of claim 18 wherein the tongue of one of the intermediate supports is engageable in the opening of the chute to secure the leading edge of the chute to the intermediate support.

20. The frame assembly of claim 18 further comprising a return bracket securable to the intermediate support, the return bracket having a pair of flanges and a coupler positioned between the flanges, the coupler including a forwardly extending bracket tongue and defining bracket notches on opposite sides of the bracket tongue.

21. The frame assembly of claim 20 wherein the bracket tongue is engageable in the opening of the chute to secure the leading edge of the chute to the return bracket.

22. A conveyor system for carrying a conveyor belt, the conveyor system comprising:
a first module having a frame and an elevator assembly supported on the frame, the elevator assembly including shuttles positioned on opposite sides of the belt, the belt supported on the frame for movement in a travel direction, the shuttles including an upper surface and being movable relative to the frame between a first position, in which the upper surface is positioned to move product along the belt, and a second position, in which the upper surface is spaced a distance from the belt in a direction substantially normal to the travel direction to remove product from the belt;
a second module for supporting the belt and transporting product from an upstream end of the second module to a downstream end of the second module; and
a third module for supporting the belt and transporting product, the third module having a drive assembly for driving the belt across the first module, the second module, and the third module.

23. The conveyor system of claim 22 wherein the first, second, and third modules are arrangable in any order.

24. The conveyor system of claim 22 wherein the conveyor system includes any combination of first, second, and third modules.

25. The conveyor system of claim 22 wherein the first module includes a second elevator assembly supported by the frame and positioned adjacent the elevator assembly.

26. The conveyor system of claim 22 wherein the second module defines a linear path for the belt.

27. The conveyor system of claim 22 wherein the second module defines a curved path for the belt.

28. The conveyor system of claim 22 wherein the belt is a first belt, the third module comprising a second belt, a transfer area defined between the first and second belts, and an intermediate conveyor positioned between the first and second belts to transfer product between the first and second belts and across the transfer area.

29. The conveyor system of claim 22 further comprising:
a pair of side support members; and
at least one intermediate support member for supporting the belt and positionable between the side support members in a first orientation to support a first belt and a second orientation to support a second belt,
wherein the side support members and the intermediate support member define the frame of the first module, a frame of the second module, and a frame of the third module.

30. The conveyor system of claim 29 wherein the intermediate support has a first surface including a forwardly extending tongue and defining notches on opposite sides of the tongue.

31. The conveyor system of claim 30 further comprising a return bracket attachable to the intermediate support member for defining a return path for the belt, the return bracket including an outwardly extending bracket tongue and bracket notches extending through the return bracket and located on opposite sides of the bracket tongue.

32. The conveyor system of claim 22 further comprising a chute for supporting the belt, the chute attachable to the frame of the first module, a frame of the second module, and a frame of the third module.

33. The conveyor system of claim 32 wherein the chute has a leading edge and a trailing edge, the leading edge including a lip defining an opening.

34. A method for selectively removing products from a conveyor of a conveyor system, the method comprising:
providing a conveyor system having a frame, a conveyor supported on the frame for movement in a travel direction relative to the frame, and support surfaces positioned on opposite sides of the conveyor, wherein the support surfaces are in a first position to allow movement of product with the conveyor;
lifting the support surfaces to a second position in which the support surfaces are spaced a distance from the conveyor in a direction substantially normal to the travel direction to remove product from the conveyor; and
retracting the support surfaces to the first position.

35. The method of claim 34 wherein in the first position the support surfaces are substantially aligned with the conveyor.

36. The method of claim 34 wherein in the first position the support surfaces are recessed from the conveyor.
